(19) United States
(12) Patent Application Publication
(10) Pub. No.: US 2025/0354834 A1
(43) Pub. Date: Nov. 20, 2025

(54) Position sensor

(71) Applicant: Continental Automotive Technologies GmbH, Hannover (DE)

(72) Inventors: Franck NIECERON, Toulouse (FR); Thomas MORIN, Toulouse (FR); Kahina TELMAT, Toulouse (FR)

(73) Assignee: Continental Automotive Technologies GmbH, Hannover (DE)

(21) Appl. No.: 19/173,250

(22) Filed: Apr. 8, 2025

(30) Foreign Application Priority Data
May 16, 2024 (FR) FR2405016

(51) Int. Cl. G01D 5/20

(52) U.S. Cl. CPC G01D 5/2053

(57) ABSTRACT

Examples set forth a position sensor for determining an angular position of a rotor of an electric motor including N pairs of poles, a vehicle with this sensor on board, a method for determining an angular position of a rotor of an electric motor, a computer program product, and a computer-readable non-transitory storage medium.

### CROSS REFERENCE TO RELATED APPLICATIONS

This application claims priority to French Application No. FR2405016, filed May 16, 2024, the contents of such application being incorporated by reference herein.

### FIELD OF THE INVENTION

The present disclosure relates to the field of position sensors.

### BACKGROUND OF THE INVENTION

The control of an electric motor takes into account many parameters. The angular position of the rotor of the electric motor is one of these parameters.

The angular position of the rotor of the electric motor can be determined in several ways, notably by means of an inductive position sensor. The angular position of the rotor estimated by inductive position sensors can include an error.

The present disclosure improves this situation.

### SUMMARY OF THE INVENTION

In this respect, a position sensor is proposed for determining an angular position of a rotor of an electric motor, the sensor comprising:
a target adapted to be fixed to the rotor of the electric motor so that it is set into rotation with the rotor during its rotational movement;
a printed circuit comprising a primary winding, K secondary windings, with K being greater than or equal to 2, and an electrical generator; and
at least one signal processing unit;
the primary winding surrounding the secondary windings;
the secondary windings assuming a shape that is adapted so that they each generate a sinusoidal electrical signal, with the generated electrical signals having a predetermined phase shift between them;
the electrical generator being adapted to deliver a current so as to create inductive coupling between the primary winding and the secondary windings, with the inductive coupling being modulated by the position of the target;
the signal processing unit being configured to:
obtain a cosine electrical signal and a sine electrical signal from the sinusoidal electrical signals;
process the cosine and sine electrical signals in order to obtain an electrical signal representing an angular position of the rotor of the electric motor; and
process the electrical signal representing the angular position of the rotor of the electric motor in order to reduce a specific harmonic of this signal, with the specific harmonic being determined from the number K of secondary windings.

Optionally, processing the cosine and sine electrical signals in order to obtain an electrical signal representing an angular position of the rotor of the electric motor corresponds to applying an atan2 mathematical function from the cosine and sine electrical signals.

Optionally, processing the electrical signal representing the angular position of the rotating element in order to reduce the specific harmonic of this signal comprises:
subtracting, from the electrical signal representing the angular position, a specific sinusoidal signal having a phase in the following form: ph=2NK+φ;
with ph corresponding to the phase of the specific sinusoidal signal;
N corresponding to a number of pairs of poles of the electric motor;
K corresponding to the number of secondary windings; and
φ corresponding to a determined phase shift.

Optionally, the determined phase shift is determined from an error signal obtained on a test bench for the position sensor or for a position sensor equivalent to the position sensor.

Optionally, an amplitude of the specific sinusoidal signal is determined from an amplitude of at least one from among the cosine electrical signal and the sine electrical signal.

Optionally, a memory having a lookup table between a plurality of amplitudes associated with at least one from among the cosine electrical signal and the sine electrical signal and a plurality of amplitudes associated with the specific sinusoidal signal.

The application also relates to a vehicle comprising such a position sensor.

The application further relates to a method for determining an angular position of a rotor of an electric motor, the method comprising:
obtaining a cosine electrical signal and a sine electrical signal originating from a printed circuit of a position sensor;
processing the cosine and sine electrical signals in order to obtain an electrical signal representing an angular position of the rotor of the electric motor;
processing the electrical signal representing the angular position of the rotor of the electric motor in order to reduce a specific harmonic of this signal, with the specific harmonic being determined from a number K of secondary windings of the position sensor.

Optionally, processing the electrical signal representing the angular position of the rotor of the electric motor in order to reduce the specific harmonic of this signal comprises:
subtracting, from the electrical signal representing the angular position, a specific sinusoidal signal having a phase in the following form: ph=2KN+φ;
with ph corresponding to the phase of the specific sinusoidal signal;
N corresponding to a number of pairs of poles of the electric motor;
K corresponding to the number of secondary windings; and
φ corresponding to a predetermined phase shift.

The application further relates to a computer program product comprising instructions for implementing any one of the methods set forth in the present disclosure when this program is executed by a processor.

Finally, the application relates to a computer-readable non-transitory storage medium storing a program for implementing any one of the methods set forth in the present disclosure when this program is executed by a processor.

### BRIEF DESCRIPTION OF THE DRAWINGS

Further features, details and advantages will become apparent upon reading the following detailed description, and with reference to the appended drawings, in which:

FIG. 1 schematically shows an example of a position sensor;

FIG. 2 schematically shows another example of an angular position sensor;

FIG. 3 schematically shows an example of a vehicle with an angular position sensor on board;

FIG. 4 schematically shows an example of a method that can be implemented by a signal processing unit of an angular position sensor;

FIG. 5 schematically shows another example of a method that can be implemented by a signal processing unit of an angular position sensor;

FIG. 6 schematically shows yet another example of a method that can be implemented by a signal processing unit of an angular position sensor;

FIG. 7 schematically shows an example of the architecture of a signal processing unit of an angular position sensor;

FIG. 8 schematically shows another example of the architecture of a signal processing unit of an angular position sensor;

FIG. 9 shows an example of an electrical signal of angular position error and an example of a specific sinusoidal signal for compensating this error;

FIG. 10 shows the example of the electrical signal of angular position error of FIG. 9 and an example of an electrical error signal corrected from the sinusoidal signal for compensating this error illustrated in FIG. 9.

### DESCRIPTION OF THE EXEMPLARY EMBODIMENTS

The inventors propose estimating the angular position of a rotating element, for example, a rotor of an electric motor, by using an inductive position sensor. This sensor uses the principle of induction to determine the position of a selected element, notably the angular position of the rotor of the electric motor.

It should be noted that the terminology used in connection with the sensors, such as “position sensor”, “angular position sensor”, “inductive sensor” and “inductive position sensor”, will be used interchangeably in the present disclosure to denote a sensor that uses the principle of induction to determine the angular position of a rotating element.

In this case, the inductive sensor creates inductive coupling between two windings, a primary winding, also called transmitter winding, and a secondary winding, also called receiver winding. An inductive target, positioned on the element whose position is to be determined, modulates, according to its position, a magnetic field created by the primary winding. In this way, the currents induced by the magnetic field in the secondary winding represent the position of the target, and therefore represent, by extension, the position of the selected element, which thus can be determined by processing the signal. More specifically, the magnetic field created by the primary winding causes eddy currents to be generated on the surface of the inductive target, which themselves generate a magnetic field in the opposite direction to that generated using the primary winding. It is this magnetic field in the opposite direction that allows induced currents to be generated in the secondary winding, with the position of the target being determined from these induced currents by signal processing. The inductive position sensor thus can include a printed circuit with both the windings and the control electronics, a conductive target positioned on the element whose position is to be determined, and a processor. The control electronics allow the electrical signals to be generated in the primary winding and allow induced signals in the secondary windings to be processed in order to obtain sinusoidal signals, called sine and cosine signals, that are well known to a person skilled in the art. For its part, the processor determines an electrical signal representing the angular position of the element whose position is to be determined (also called electrical angle signal in the present disclosure) from the sine and cosine signals.

The inventors have particularly noted that when the inductive sensor includes a primary winding surrounding at least two secondary windings assuming a shape corresponding to a projection in polar coordinates in a space delimited by the primary winding with a sinusoidal shape in a Cartesian plane, the intrinsic features of the sensor lead to the formation of current harmonics that introduce an error in the electrical angle signal determined by the processor. They also noted that the order of the harmonics with a relatively significant impact on the error in the position determined by the processor depends on the number and the arrangement of the secondary windings of the sensor.

The inventors have noted, for example, that a first topology of an inductive sensor comprising a primary winding surrounding only two secondary windings assuming a shape corresponding to a projection in polar coordinates in a space delimited by the primary winding with a sinusoidal shape in a Cartesian plane, causes the formation of even harmonics with an order that is equal to or greater than 4 on the electrical signal for determining the position of the target. Moreover, insofar as the amplitude of the harmonics decreases with their order, the inventors have noted that the 4th-order harmonic introduces the most significant proportion of error in the position of the target determined by this first sensor topology.

The inventors have also noted that a second topology of an inductive sensor, comprising a primary winding surrounding only three secondary windings assuming a shape corresponding to a projection in polar coordinates in a space delimited by the primary winding with a sinusoidal shape in a Cartesian plane, causes the formation of even harmonics with an order that is equal to or greater than 6 on the signals for determining the position of the target. Furthermore, for this second sensor topology, the inventors identified that it was the 6th-order harmonic that introduced the most significant proportion of error in the determined target position. The error generated by the second sensor topology on the angular position of the target, mainly instigated by the 6th-order harmonic, is thus less than the error generated by the first sensor topology insofar as its error is, for its part, mainly instigated by the 4th-order harmonic.

In the present application, inductive sensor topology is understood to mean a shape and an arrangement of the primary and secondary windings. Notably, the same sensor topology comprises the same number of secondary windings with the same predetermined phase shift between them, as well as a primary winding that surrounds the secondary windings in the same way (for example, by encircling them).

The inventors thus identified solutions that allow the error of the inductive position sensor to be reduced by modifying the arrangement and the number of primary windings. Notably, a description has been provided concerning the fact that a topology using three secondary windings introduced even harmonics with an order that is greater than or equal to 6 in the angle signal, while the topology using two secondary windings introduced pairs with an order that is greater than or equal to 4 in the angle signal. However, although these solutions allow the error in the target position to be reduced, they are complex to implement insofar as they involve defining and manufacturing suitable secondary windings and the appropriate processing of the signals according to the defined secondary windings. These solutions are therefore costly in terms of research and development, and focus on processing the signal on the printed circuit of the inductive position sensor.

In the present disclosure, the inventors propose an ingenious solution that involves processing the electrical signal representing the angular position of the rotor of the electric motor in order to reduce a specific harmonic of this signal, with the specific harmonic being determined from the number K of secondary windings of the sensor. This angle signal is determined by a signal processing unit that may form an integral part of the printed circuit of the inductive position sensor, or may be partly remote, notably for the digital signal processing part. Thus, the solution presented by the present disclosure directly relates to processing the electrical angle signal so as to reduce the specific harmonic of this signal that instigates the largest proportion of angle error from among the harmonics of the signal. Furthermore, the intention is not to modify the number, the shape or the arrangement of the coils, nor the processing of the electrical signals generated before obtaining the electrical angle signal, but rather to modify the initially obtained processed electrical angle signal in order to reduce a specific harmonic of this signal identified as corresponding to the harmonic instigating the most significant angle error. The solution proposed in the present disclosure therefore allows the error in the position determined by the sensor to be reduced in a simple manner, since the error is directly identified in the electrical angle signal, so that it is possible to act on this error without modifying the arrangement of the sensor or the preliminary processing steps used to obtain this angle signal.

The inventors have notably noted that the angle error obtained in the electrical signal representing the angular position of the target (i.e., the angle signal) was repeatable and therefore could be characterized by a sinusoidal signal with a predetermined phase dependent on the number of secondary windings of the inductive sensor and on the number of pairs of poles of the motor. Notably, this sinusoidal signal characterizing the error can be predetermined on a test bench and subtracted from the electrical angle signal so as to reduce and possibly eliminate this angle error.

Furthermore, insofar as direct processing of the electrical angle signal to reduce a specific harmonic of this signal allows the error of this signal to be reduced, this processing can be implemented by the processor of the existing position sensors that already determines the angle signal from the sine and cosine signals provided by the integrated circuit of the position sensor, without modifying the hardware composition of the inductive position sensor. Notably, when the inductive angular position sensor is on board a vehicle comprising an electric motor, the processing of the sine and cosine signals to determine the electrical angle signal of the rotor of the electric motor and the processing of this angle signal to reduce its error can be performed by the electronic control unit (ECU) of said vehicle.

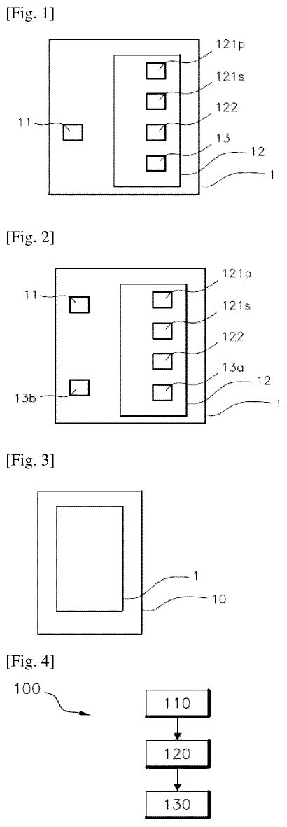

With reference to FIGS. 1 and 2, an example of a position sensor 1 for determining an angular position of a rotor of an electric motor (not shown) will now be described. The position sensor 1 notably can be on board a vehicle 10 comprising an electric motor (not shown), as schematically illustrated in FIG. 3.

The angular position can be defined as a measurement of the rotational position of an element relative to a reference axis. The reference axis can correspond, for example, to the axis around which the rotor is set into rotation.

The electric motor comprises N pairs of poles. N denotes an integer greater than or equal to 1. A pair of poles N of an electric motor is made up of two opposite magnetic poles that generate a magnetic field.

The position sensor 1 comprises a target 11 adapted to be fixed to the rotor of the electric motor so that it is set into rotation with the rotor during its rotational movement. The target corresponds to an inductive target, i.e., a target that allows the conduction of an electric current (notably the conduction of eddy currents), and therefore the generation of a magnetic field. Consequently, the target 11 is formed by a conductive material, for example, a metal, notably iron, copper, aluminum, or even a specific metal alloy.

The target 11 can assume various known shapes that will not be described in the present patent application. Notably, the shape of the target depends, in a well-known manner, on the number N of pairs of poles of the electric motor.

The position sensor 1 also comprises a printed circuit 12. The printed circuit 12 can correspond to a plate or a substrate, generally made of insulating material, on which conductor tracks are arranged. These tracks connect various electronic components together in order to form a functional electrical circuit.

The printed circuit 12 comprises a primary winding 121p, K secondary windings 121s and an electrical generator 122. K is a natural integer greater than or equal to 2. The primary winding surrounds the secondary windings 121s.

In a known manner, when the sensor is installed, the printed circuit board 12 must be fixed in position, facing the target 11. More specifically, the secondary windings 121 of the printed circuit 12 must be positioned opposite the target in order to receive the magnetic field generated by the target and thus generate electrical signals.

The electrical generator 122 is adapted to deliver a current so as to create inductive coupling between the primary winding 121p and the secondary windings 121s.

The inductive coupling between the windings 121 is modulated by the angular position of the target 11. Notably, the electrical generator 121 can correspond to an alternating current generator connected to the primary winding 121p so that the generation of current in the primary winding 121p produces a magnetic field that generates eddy currents in the target. The eddy currents flowing through the target also produce a magnetic field, which generates an induced current in the secondary windings 121s. The phase shift between the currents generated in the secondary windings 121s allows an angular position of the target 11 to be determined.

The secondary windings 121s are shaped in such a way that they each generate a sinusoidal electrical signal as a function of the angular position of the target 11. The secondary windings 121s are notably arranged to have a predetermined phase shift between them. This predetermined phase shift is a function of the number K of secondary windings 121s. This is a known arrangement of windings of an angular position sensor. Thus, the electrical signals generated by the secondary windings 121s, due to the geometric phase shift between these windings, exhibit a phase shift that allows the angular position of the target to be determined.

The secondary windings 121s can assume, for example, a known shape corresponding to a projection in polar coordinates, in a space delimited by the primary winding, of a sinusoidal shape in a Cartesian plane. Notably, the primary winding 121p can be in the shape of a circle and can encircle the secondary windings 121s. In these known examples, the secondary windings 121s are included in a plane radial to the circle formed by the primary winding 121p that surrounds them.

In first examples, there are two secondary windings 121s (K=2), and the phase shift between them corresponds to 180° or π/2 radians.

In second examples, there are three secondary windings 121s (K=3), and the phase shift between them corresponds to 120° or π/3 radians.

As explained above, the inventors have astutely noted that the signal representing the angular position of the rotor of the electric motor included an angle error signal characterized by a specific harmonic that depends on the number of secondary windings 121s of the angular position sensor. Notably, when the sensor comprises two secondary windings 121s, the specific harmonic is a 4th-order harmonic of the signal. In the case of a position sensor 1 comprising three secondary windings 121s, the specific harmonic corresponds to a 6th-order harmonic of the signal representing the angular position of the rotor of the electric motor.

The position sensor 1 also comprises a signal processing unit 13. The signal processing unit 13 of the position sensor 1 is configured to implement several operations described with reference to FIGS. 4 to 6, which schematically illustrate examples of signal processing methods 100. These are operations processing both analog and digital signals, as described hereafter.

In first examples, the signal processing unit 13 can be fully integrated into the printed circuit 12, as shown in FIG. 1. In this case, the signal processing unit 13 can be configured to process both analog and digital signals. It can therefore include an analog signal processing unit 131, an analog-to-digital converter CAN for converting analog signals into digital signals, and a processor PROC associated with a memory MEM for processing the digital signals. An example of a signal processing unit 13 according to the first examples is notably shown in FIG. 7. It is understood that such a fully integrated processing unit 13 could therefore implement the examples of methods 100 directly on the printed circuit 12.

In some examples, the memory MEM can store the code instructions executed by the processor PROC and can optionally store the electrical signals digitized by the analog-to-digital converter CAN. The processor PROC therefore has access to the information stored in the memory MEM.

The memory MEM can include, for example, a ROM (Read-Only Memory), a RAM (Random Access Memory), an EEPROM (Electrically Erasable Programmable Read-Only Memory) or any other type of suitable storage media. The memory MEM can include, for example, optical, electronic or even magnetic storage media.

The processor PROC can correspond, for example, to a controller, notably a microcontroller.

In second examples, the signal processing unit 13 can comprise two parts 13a and 13b. The first part 13a is integrated into the printed circuit 12. The second part 13b, for its part, is outside the printed circuit 12, as shown in FIG. 2.

The first part 13a of the signal processing unit 13 can be adapted to process analog signals and then send the processed analog signals to the second part 13b of the signal processing unit. The second part 13b of the signal processing unit 13 can be adapted to convert the analog signals into digital signals and then to process the digital signals.

The first part 13a of the signal processing unit 13 therefore can include the analog signal processing unit 131 for processing analog signals and a communication unit COM for sending analog signals to the second part 13b of the signal processing unit.

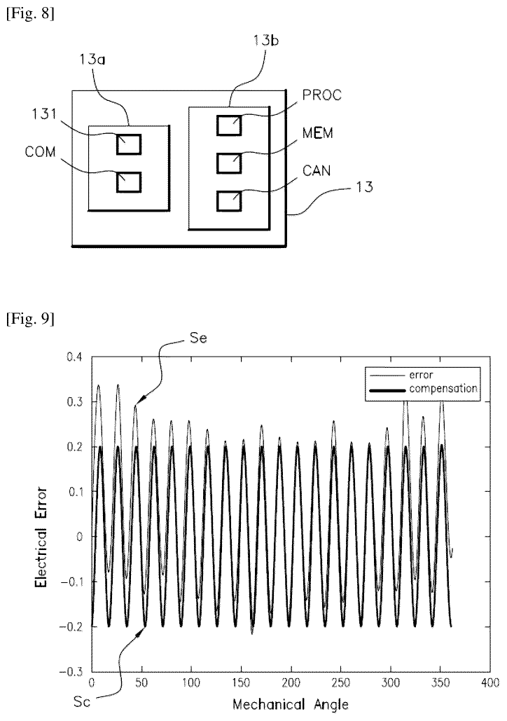

The second part 13b of the signal processing unit 13, for its part, can include the analog-to-digital converter CAN for converting the analog signals into digital signals, and the processor PROC associated with the memory MEM for processing the digital signals. An example of a signal processing unit 13 according to the second examples is notably shown in FIG. 8.

In examples in which the angular position sensor is on board a vehicle, the processor PROC of the second part 13b of the signal processing unit 13 can correspond to the electronic control unit of the vehicle.

It is understood that in these second examples of the architecture of the signal processing unit 13, the analog signal processing operations are performed by the first part 13a of the unit 13 on the printed circuit 12, while the digital signal processing operations are implemented by the second part 13b of the unit 13, notably by a processor PROC, outside the printed circuit 12.

Thus, the signal processing unit 13 is configured to implement operations of the example of methods 100 described with reference to FIGS. 4 to 6.

As illustrated by the block 110, the signal processing unit 13 is configured to obtain 110 a cosine electrical signal and a sine electrical signal from the sinusoidal electrical signals generated by the secondary windings 121s. In this case, as previously explained, the sinusoidal electrical signals are generated by inductive coupling, which coupling is modulated by the position of the target.

The cosine electrical signal and the sine electrical signal refer to two sinusoidal electrical signals, derived from the sinusoidal electrical signals generated by the secondary windings, and which are used to determine an electrical signal representing the angular position of the rotor of the electric motor by signal processing.

Various known techniques allow cosine and sine signals to be obtained for this type of angular position sensor.

Notably, in examples in which the position sensor comprises two secondary windings 121s, the cosine and sine signals can directly correspond to the two electrical signals generated by the two secondary windings.

In other examples in which the position sensor also comprises two secondary windings 121s, one of the two secondary windings can be used to obtain a signal called cosine+ signal and a signal called cosine-signal, while the other secondary winding can be used to obtain a signal called sine+ signal and a signal called sine-signal. In these other examples, the cosine electrical signal is obtained by a difference between the cosine+ and cosine− signals, while the sine electrical signal is obtained by a difference between the sine+and sine− signals. This differentiation of signals (cosine+/cosine− and sine+/sine−) allows the intrinsic noise of the cosine and sine signals to be reduced compared to cosine and sine signals obtained directly from the electrical signals generated by the secondary windings.

In some examples in which the position sensor comprises three secondary windings 121s, the cosine and sine electrical signals can be obtained by a complex computation step (via a Park Transform, for example) to project the three signals generated by the secondary windings 121s (three-phase system) into a coordinate space comprising only two signals (two-phase system).

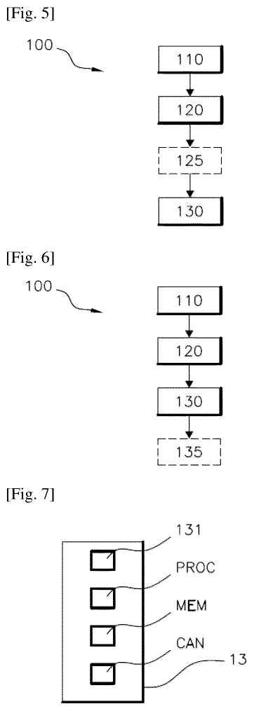

As illustrated by the block 120, the signal processing unit 13 is configured to process 120 the cosine and sine electrical signals in order to obtain an electrical signal representing the angular position of the rotor of the electric motor. In some examples, notably illustrated by the block 125 in FIG. 5, processing the cosine and sine electrical signals in order to obtain an electrical signal representing the angular position of the rotor of the electric motor corresponds to applying an atan2 mathematical function from the cosine and sine electrical signals. The use of the atan2 mathematical function from the sine and cosine signals in order to obtain a signal representing the angular position of the rotor of the electric motor corresponds to a known operation for this type of inductive sensor.

As illustrated by the block 130, the signal processing unit 13 is configured to process the electrical signal representing the angular position of the rotor of the electric motor in order to reduce a specific harmonic of this signal. The specific harmonic is determined from the number K of secondary windings 121s. The specific harmonic can be determined to correspond to the harmonic of the signal corresponding to the angular error exhibiting the highest proportion of error, with this harmonic being dependent on the number K of secondary windings 121s used.

The signal processing unit 13 of the position sensor 1 is therefore configured to reduce the error in the angular position determined by the sensor by acting directly on the electrical angle signal so as to reduce the specific harmonic of this signal that instigates the largest proportion of angle error from among the signal harmonics. Furthermore, the configuration of the processing unit according to the present disclosure allows, unlike the solutions contemplated to date for reducing this error, the existing hardware and software architecture of the inductive position sensors to be maintained, by ingeniously adding a post-processing step for reducing errors on the initially obtained angle signal. The solution is particularly advantageous in that it can be implemented on inductive sensors with a different number of secondary windings (in particular for inductive position sensors with 2 or 3 secondary windings).

It is also understood that, insofar as direct processing of the electrical angle signal for reducing a specific harmonic of this signal allows the error of this signal to be reduced, this processing can be implemented by the processor of existing position sensors that already determines the angle signal from the sine and cosine signals provided by the integrated circuit of the position sensor, without modifying the hardware architecture of the inductive position sensor. Thus, when the inductive angular position sensor is on board a vehicle, the processing of the sine and cosine signals to determine the electrical angle signal of a rotor of an electric motor of the vehicle, and the processing of this angle signal to reduce its error, can be performed directly by the electronic control unit of said vehicle.

In some examples, when the signal processing unit 13 processes 130 the electrical signal representing the angular position of the rotating element in order to reduce the specific harmonic of this signal, the signal processing unit 130 can be configured to implement the operation 135. These examples are notably shown in FIG. 6.

The operation 135 involves subtracting, from the electrical signal representing the angular position, a specific sinusoidal signal having a phase in the following form:
ph=2NK+φ,
with ph corresponding to the phase of the specific sinusoidal signal;
N corresponding to the number of pairs of poles of the electric motor;
K corresponding to the number of secondary windings; and
φ corresponding to a determined phase shift.

The inventors have cleverly noted that the angle error instigated by the specific harmonic instigating the greatest proportion of the error in the angle signal was repeatable insofar as this error is intrinsic to the technology on which the sensor is based. This error in the angle signal mainly instigated by the specific harmonic thus can be reduced or even eliminated by subtracting a sinusoidal signal from the angle signal, with the phase of the sinusoidal signal being 2NK proportional to the phase of the signal, to which a constant phase shift φ is added.

φ is a constant phase shift in the sense that it does not change dynamically. In other words, it is independent of time. In this case, the phase shift φ depends on the topology of the sensor and on the manufacturer. Notably, sensors from the same manufacturer with the same topology share the same phase shift φ. This phase shift φ therefore can be determined on a test bench for an inductive position sensor from a given manufacturer with a specific topology. Alternatively, the phase shift φ can be determined when the sensor is operating.

In some examples, the phase shift φ is determined from an error signal obtained on a test bench for the position sensor or for a position sensor equivalent to the position sensor 1. The error signal corresponds to a differential signal resulting from a difference between the signal representing the angular position of the position sensor or the equivalent position sensor obtained by processing cosine and sine signals and a real angular position signal reconstructed from direct measurements of the angular position of the target of the relevant sensor on the test bench.

A position sensor equivalent to the position sensor 1 in this case must be understood to be an inductive position sensor from the same manufacturer with primary and secondary windings similar in shape and arrangement to those of the position sensor 1, as well as an inductive target adapted to be fixed to a rotor of an electric motor comprising the same number N of pairs of poles as the target of the position sensor 1. Notably, the number K of secondary windings of the equivalent sensor must correspond to the number K of secondary windings of the position sensor 1 and must have a phase shift that is substantially equal to the phase shift of the secondary windings of the position sensor 1. A position sensor equivalent to the position sensor 1 can correspond, for example, to another position sensor of the same model (therefore, of the same topology and from the same manufacturer), possibly manufactured on the same production line.

In first examples in which the inductive position sensor has a topology with a printed circuit comprising a primary winding surrounding only two secondary windings with a shape corresponding to a projection in polar coordinates in a space delimited by the primary winding with a sinusoidal shape in a Cartesian plane, the sinusoidal signal to be subtracted during the operation 135 can exhibit a phase in the following form:
ph=4N+φ,
with ph corresponding to the phase of the specific sinusoidal signal;
N corresponding to the number of pairs of poles of the electric motor; and
φ corresponding to a determined phase shift.

In second examples in which the inductive position sensor has a topology with a printed circuit comprising a primary winding surrounding only three secondary windings that assume a shape corresponding to a projection in polar coordinates in a space delimited by the primary winding with a sinusoidal shape in a Cartesian plane, the sinusoidal signal to be subtracted during the operation 135 can exhibit a phase in the following form:
ph=6N+φ,
with ph corresponding to the phase of the specific sinusoidal signal;
N corresponding to the number of pairs of poles of the electric motor; and
φ corresponding to a determined phase shift.

In some examples of the sensor 1 in which the signal processing unit 13 is configured to implement the operation 135, an amplitude of the specific sinusoidal signal subtracted from the electrical signal representing the angular position can be determined from an amplitude of at least one from among the cosine electrical signal and the sine electrical signal. In other words, the amplitude of the specific sinusoidal signal can be determined from the amplitude of the sine electrical signal, or from the amplitude of the cosine electrical signal, or from the amplitude of both these signals.

The inventors have noted that the amplitude of the sinusoidal signal for applying a correction to the angle signal was proportional to the amplitude of the cosine and sine signals obtained by the sensor. Furthermore, rather than defining a “default” amplitude for the specific sinusoidal correction signal that could, for example, have been previously determined on a test bench, these examples propose determining an amplitude based on the actual amplitudes of the determined cosine and sine signals. The amplitude of the specific sinusoidal signal therefore can be adapted as a function of the levels of the sine and cosine signals actually obtained when using the sensor, rather than being defined, a priori, by measuring these amplitudes on a test bench. Furthermore, it is also understood that these examples allow the amplitude of the corrective signal that is to be applied to be dynamically modified as a function of the amplitudes of the cosine and/or sine signals obtained when using the sensor, which is not permitted when the amplitude is fixed a priori.

In some examples in which the amplitude of the specific sinusoidal signal is determined from the amplitude of at least one from among the cosine electrical signal and the sine electrical signal, a sensor memory, for example, the memory MEM, can have a lookup table between a plurality of amplitudes associated with the at least one from among the cosine electrical signal and the sine electrical signal and a plurality of amplitudes associated with the specific sinusoidal signal. Thus, the amplitude of the specific sinusoidal signal can be determined from an amplitude of the specific sinusoidal signal of the table associated with the amplitude of the at least one from among the determined cosine electrical signal and the sine electrical signal.

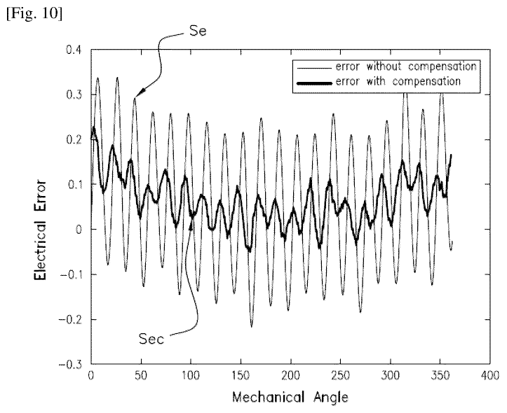

FIGS. 9 and 10 graphically show the impact of the operation 135 on the angle signal error determined by the angular position sensor 1. In particular, FIG. 9 graphically shows an example of an electrical signal Se representing the error in the angular position of the rotor of the electric motor and an example of a specific sinusoidal signal Sc for at least partly compensating for this electrical error signal Se. FIG. 10, for its part, shows the same example of an electrical error signal Se and a compensated electrical error signal Sec resulting from a difference between the electrical error signal Se and the specific sinusoidal signal Sc. In these two figures, the abscissa axis represents the angular position of the rotor of the electric motor in degrees (ranging from 0 to 360°), while the ordinate axis represents the electrical error, also in degrees. These graphs highlight the fact that the operation 135 of subtracting the specific sinusoidal signal significantly reduces the error in the angular position determined by the position sensor.

The solution set forth in the present disclosure therefore allows an error to be attenuated or even eliminated that is instigated by a specific harmonic of the angle signal determined by an inductive position sensor. This solution relies on post-processing of the angle signal, which can be implemented in software, so that the electronic architectures of existing inductive sensors do not necessarily need to be modified in order to implement this solution. Furthermore, the solution can be applied to several different topologies of inductive sensors, notably those with two or three secondary windings.

1. A position sensor for determining an angular position of a rotor of an electric motor, the sensor comprising:
a target adapted to be fixed to the rotor of the electric motor so that it is set into rotation with the rotor during its rotational movement;
a printed circuit comprising a primary winding, K secondary windings, with K being greater than or equal to 2, and an electrical generator; and
a signal processing unit;
the primary winding surrounding the secondary windings;
the secondary windings assuming a shape that is adapted so that they each generate a sinusoidal electrical signal, with the generated electrical signals having a predetermined phase shift between them;
the electrical generator being adapted to deliver a current so as to create inductive coupling between the primary winding and the secondary windings, with the inductive coupling being modulated by the position of the target;
the signal processing unit being configured to:
obtain a cosine electrical signal and a sine electrical signal from the sinusoidal electrical signals;
process the cosine and sine electrical signals in order to obtain an electrical signal representing an angular position of the rotor of the electric motor; and
process the electrical signal representing the angular position of the rotor of the electric motor in order to reduce a specific harmonic of this signal, with the specific harmonic being determined from the number K of secondary windings, the processing of the electrical signal comprising:
subtracting, from the electrical signal representing the angular position, a specific sinusoidal signal having a phase in the following form: ph=2NK+φ;
with ph corresponding to the phase of the specific sinusoidal signal;
N corresponding to a number of pairs of poles of the electric motor;
K corresponding to the number of secondary windings; and
φ corresponding to a determined phase shift.

2. The sensor as claimed in claim 1, wherein processing the cosine and sine electrical signals in order to obtain an electrical signal representing an angular position of the rotor of the electric motor corresponds to applying an atan2 mathematical function from the cosine and sine electrical signals.

3. The sensor as claimed in claim 2, wherein the determined phase shift is determined from an error signal obtained on a test bench for the position sensor or for a position sensor equivalent to the position sensor.

4. The sensor as claimed in claim 2, wherein an amplitude of the specific sinusoidal signal is determined from an amplitude of at least one from among the cosine electrical signal and the sine electrical signal.

5. The sensor as claimed in claim 4, further comprising a memory (MEM) having a lookup table between a plurality of amplitudes associated with at least one from among the cosine electrical signal and the sine electrical signal and a plurality of amplitudes associated with the specific sinusoidal signal.

6. A vehicle comprising a sensor as claimed in claim 1.

7. A method for determining an angular position of a rotor of an electric motor, the method comprising:
obtaining a cosine electrical signal and a sine electrical signal originating from a printed circuit of a position sensor;
processing the cosine and sine electrical signals in order to obtain an electrical signal representing an angular position of the rotor of the electric motor;
processing the electrical signal representing the angular position of the rotor of the electric motor in order to reduce a specific harmonic of this signal, with the specific harmonic being determined from a number K of secondary windings of the position sensor, the processing of the electrical signal comprising:
subtracting, from the electrical signal representing the angular position, a specific sinusoidal signal having a phase in the following form: ph=2KN+φ;
with ph corresponding to the phase of the specific sinusoidal signal;
N corresponding to a number of pairs of poles of the electric motor;
K corresponding to the number of secondary windings; and
φ corresponding to a predetermined phase shift.

8. A non-transitory computer program product comprising instructions for implementing a method as claimed in claim 7.

9. The sensor as claimed in claim 3, wherein an amplitude of the specific sinusoidal signal is determined from an amplitude of at least one from among the cosine electrical signal and the sine electrical signal.
